(19) United States
(12) Patent Application Publication
(10) Pub. No.: US 2026/0145426 A1
(43) Pub. Date: May 28, 2026

(54) LIQUID JET HEAD AND LIQUID JET RECORDING APPARATUS

(71) Applicant: SII Printek Inc., Chiba-shi (JP)

(72) Inventor: Yukihiro SAGA, Chiba-shi (JP)

(21) Appl. No.: 19/397,165

(22) Filed: Nov. 21, 2025

(30) Foreign Application Priority Data
Nov. 28, 2024 (JP) 2024-207557

(51) Int. Cl. B41J 2/045

(52) U.S. Cl. CPC B41J 2/04588; B41J 2/04543; B41J 2/04581; B41J 2/0459; B41J 2/04591

(57) ABSTRACT

A liquid jet head and so on capable of enhancing the convenience while reducing the cost are provided. The liquid jet head according to an embodiment of the present disclosure includes a jet section including a plurality of nozzles and a plurality of pressure chambers individually communicated with the plurality of nozzles, and a single drive circuit or a plurality of drive circuits configured to generate a drive signal for jetting a liquid from the nozzle based on image data defining a drive waveform and an additional signal. In at least one drive circuit out of the single drive circuit or the plurality of drive circuits, the drive signals having the drive waveforms of a plurality of types defined by the additional signal are configured to be respectively generated based on the same image data and to be output to the jet section.

### RELATED APPLICATIONS

This application claims priority to Japanese Patent application No. JP2024-207557, filed on Nov. 28, 2024, the entire content of which is incorporated herein by reference.

### BACKGROUND OF THE INVENTION

### 1. Field of the Invention

The present disclosure relates to a liquid jet head and a liquid jet recording apparatus.

### 2. Description of the Related Art

Liquid jet recording apparatuses equipped with liquid jet heads are used in a variety of fields, and a variety of types of liquid jet heads are developed.

In such a liquid jet head, in general, it is required to reduce the cost, and to enhance the convenience.

It is desirable to provide a liquid jet head and a liquid jet recording apparatus capable of enhancing the convenience while reducing the cost.

### SUMMARY OF THE INVENTION

The liquid jet head according to an embodiment of the present disclosure includes a jet section including a plurality of nozzles and a plurality of pressure chambers individually communicated with the plurality of nozzles, and a single drive circuit or a plurality of drive circuits configured to generate a drive signal for jetting a liquid from the nozzle based on image data defining a drive waveform and an additional signal. In at least one drive circuit out of the single drive circuit or the plurality of drive circuits, the drive signals having the drive waveforms of a plurality of types defined by the additional signal are configured to be respectively generated based on the same image data and to be output to the jet section.

The liquid jet recording apparatus according to an embodiment of the present disclosure is equipped with the liquid jet head according to an embodiment of the present disclosure described above.

According to the liquid jet head and the liquid jet recording apparatus related to the embodiment of the present disclosure, it becomes possible to enhance the convenience while reducing the cost.

### BRIEF DESCRIPTION OF THE DRAWINGS

FIG. 1 is a block diagram showing an outline configuration example of a liquid jet recording apparatus according to an embodiment of the present disclosure.

FIG. 2 is a block diagram showing a detailed configuration example of a drive board shown in FIG. 1.

FIG. 3 is a block diagram showing a detailed configuration example of a drive circuit shown in FIG. 2.

FIG. 4 is a diagram showing a detailed configuration example of an additional signal shown in FIG. 3.

FIGS. 5A and 5B are each a schematic diagram showing a configuration example of drive waveforms and so on stored in a waveform storage unit shown in FIG. 1 to FIG. 3.

FIG. 6 is a schematic diagram showing a configuration example of drive waveforms and so on stored in a waveform storage unit related to a comparative example.

FIGS. 7A, 7B and 7C are schematic diagrams showing an example of a correspondence relationship among a print image, the number of drops, and image data related to the comparative example.

FIGS. 8A, 8B and 8C are schematic diagrams showing an example of a correspondence relationship among a print image, the number of drops, and image data related to practical examples.

### DETAILED DESCRIPTION OF THE PREFERRED EMBODIMENTS

An embodiment of the present disclosure will hereinafter be described in detail with reference to the drawings. It should be noted that the description will be presented in the following order.
1. Embodiment (An example in which drive signals of a plurality of types of drive waveforms are generated from the same image data)
2. Modified Examples

### 1. Embodiment

### Outline Configuration of Printer 5

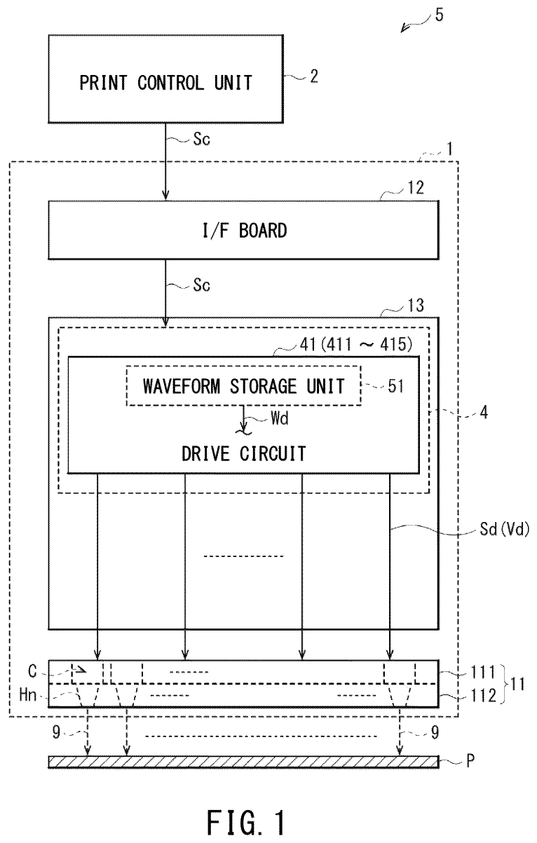

FIG. 1 is a block diagram showing an outline configuration example of a printer 5 as a liquid jet recording apparatus according to an embodiment of the present disclosure. It should be noted that a scale size of each of the members is appropriately altered so that the member is shown in a recognizable size in the drawings used in the description of the present specification.

The printer 5 is an inkjet printer that performs recording (printing) of images, characters, and the like on a recording target medium (e.g., recording paper P shown in FIG. 1) using ink 9 described later. As shown in FIG. 1, the printer 5 is mainly provided with an inkjet head 1 and a print control unit 2.

It should be noted that the inkjet head 1 corresponds to a specific example of a “liquid jet head” in the present disclosure, and the printer 5 corresponds to a specific example of a “liquid jet recording apparatus” in the present disclosure. Further, the ink 9 corresponds to a specific example of a “liquid” in the present disclosure.

### A. Print Control Unit 2

The print control unit 2 is for supplying the inkjet head 1 with a variety of types of information (data). Specifically, as shown in FIG. 1, the print control unit 2 is arranged to supply each of elements (drive circuits 41 described later and so on) in the inkjet head 1 with a print control signal Sc.

It should be noted that the print control signal Sc is arranged to include, for example, image data Dp, an ejection timing signal, and a power supply voltage (a drive power supply) for making the inkjet head 1 operate described later.

### B. Inkjet Head 1

The inkjet head 1 is a head for jetting (ejecting) the ink 9 shaped like a droplet from a plurality of nozzle holes Hn described later to the recording paper P as indicated by dotted arrows in FIG. 1 to thereby perform recording of images, characters, and so on.

As shown in FIG. 1, the inkjet head 1 is provided with a single jet section 11, a single I/F (interface) board 12, and a single drive board 13.

### B-1. Jet Section 11

As shown in FIG. 1, the jet section 11 is a section which has the plurality of nozzle holes Hn, and which jets the ink 9 from these nozzle holes Hn. Such jet of the ink 9 is arranged to be performed (see FIG. 1) based on drive signals Sd (drive voltages Vd) output from the drive circuits 41 described later on the drive board 13.

As shown in FIG. 1, such a jet section 11 is configured including an actuator plate 111 and a nozzle plate 112. It should be noted that it is arranged that the ink 9 is supplied to the jet section 11 (the actuator plate 111) from, for example, an ink tank (not shown in FIG. 1) in the inkjet head 1 via an ink supply tube.

### Nozzle Plate 112

The nozzle plate 112 is a plate formed of a film material such as polyimide, or a metal material, and has the plurality of nozzle holes Hn described above as shown in FIG. 1. These nozzle holes Hn are formed side by side at predetermined intervals, and each have, for example, a circular shape. It should be noted that such two or more nozzle holes Hn each correspond to a specific example of a “nozzle” in the present disclosure.

### Actuator Plate 111

The actuator plate 111 is a plate formed of a piezoelectric material such as PZT (lead zirconate titanate). The actuator plate 111 is provided with a plurality of channels C (pressure chambers). These channels C are each a part for applying pressure to the ink 9, and are arranged side by side so as to be parallel to each other at predetermined intervals. Each of the channels C is partitioned by drive walls (not shown) formed of a piezoelectric body, and forms a groove part having a recessed shape in a cross-sectional view.

As such channels C, there exist ejection channels for ejecting the ink 9, and dummy channels (non-ejection channels) which do not eject the ink 9. In other words, it is arranged that the ejection channels are filled with the ink 9 on the one hand, but the dummy channels are not filled with the ink 9 on the other hand. It should be noted that it is arranged that filling of each of the ejection channels with the ink 9 is performed via, for example, a flow channel (a common flow channel) commonly communicated with such ejection channels. Further, it is arranged that each of the ejection channels is individually communicated with the nozzle hole Hn in the nozzle plate 112 on the one hand, but each of the dummy channels is not communicated with the nozzle hole Hn on the other hand. The ejection channels and the dummy channels are alternately disposed side by side along a predetermined direction.

Further, on the inner side surfaces opposed to each other in the drive walls described above, there are respectively disposed drive electrodes. As the drive electrodes, there exist common electrodes disposed on the inner side surfaces facing the ejection channels, and active electrodes (individual electrodes) disposed on the inner side surfaces facing the dummy channels. These drive electrodes and drive circuits 41 described later are electrically coupled to each other via the drive board 13. Thus, it is arranged that the drive voltages Vd (the drive signals Sd) described above are applied from the drive circuits 41 to the drive electrodes via the drive board 13 (see FIG. 1).

### B-2. I/f Board 12

As shown in FIG. 1, the I/F board 12 is a board (a relay board) intervening between the drive board 13 and an outside (the print control unit 2) of the inkjet head 1. Thus, it is arranged that the print control signal Sc input from the print control unit 2 is supplied to the drive board 13 (the drive circuits 41 and so on) via the I/F board 12.

### B-3. Drive Board 13

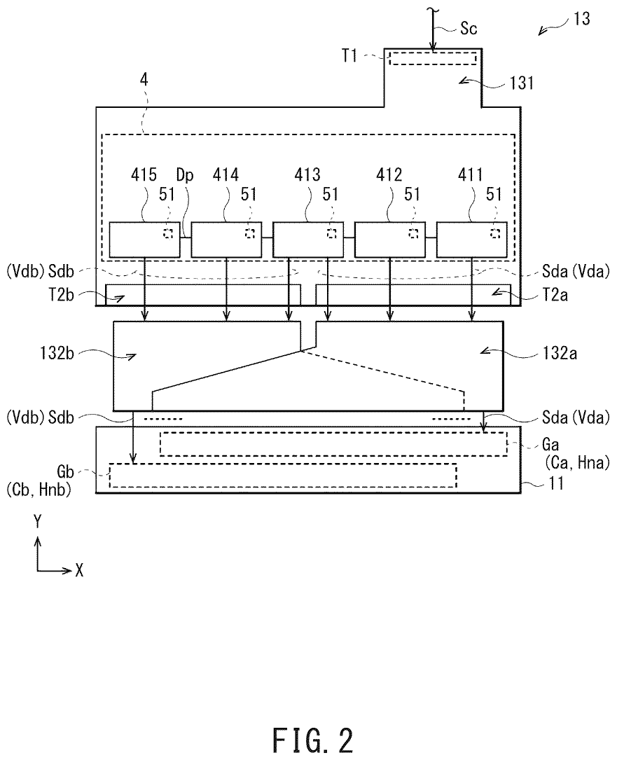

FIG. 2 is a block diagram showing a detailed configuration example of the drive board 13 shown in FIG. 1.

As shown in FIG. 1 and FIG. 2, the drive board 13 is a board which electrically couples the I/F board 12 and the jet section 11 to each other, and is arranged to individually control a jet operation of the ink 9 in the nozzle plate 112 described above by outputting the drive signals Sd (drive signals Sda, Sdb described later) described above from the drive circuit 41. As shown in FIG. 2, this drive board 13 is provided with a single drive circuit board 131 and two flexible wiring boards 132a, 132b.

The drive circuit board 131 has terminal sections T1, T2a, and T2b and a drive circuit section 4 including a single drive circuit 41 or a plurality of drive circuits 41 (five drive circuits 411 to 415 in the example in FIG. 2). The terminal section T1 includes a terminal to which the print control signal Sc described above is input. The terminal section T2a corresponds to terminals to which the drive signals Sda as the drive signals Sd are input from the drive circuits 411 to 413 toward the flexible wiring board 132a. Meanwhile, the terminal section T2b corresponds to terminals to which the drive signals Sdb as the drive signals Sd are input from the drive circuits 413 to 415 toward the flexible wiring board 132b.

The drive circuits 41 (411 to 415) are circuits which generate and then output the drive signals Sd (the drive voltages Vd) described above for jetting the ink 9 from the nozzle holes Hn in the jet section 11. The drive circuits 411 to 415 each include a waveform storage unit 51 described later (see FIG. 1 and FIG. 2). Further, in the example shown in FIG. 2, these two or more drive circuits 411 to 415 are cascaded to each other via a common signal line group (a signal line group such as image data Dp).

As shown in FIG. 2, the drive circuits 411 to 413 are each a circuit which generates the drive signals Sda (drive voltages Vda as the drive voltages Vd) described above to supply the drive signals Sda to the jet section 11 via the terminal section T2a and the flexible wiring board 132a. Meanwhile, the drive circuits 413 to 415 are each a circuit which generates the drive signals Sdb (drive voltages Vdb as the drive voltages Vd) described above to supply the drive signals Sdb to the jet section 11 via the terminal section T2b and the flexible wiring board 132b. That is, in particular, the drive circuit 413 is arranged to supply both the drive signals Sda, Sdb (the drive voltages Vda, Vdb) to the jet section 11.

Here, as shown in FIG. 2, in the present embodiment, the plurality of nozzle holes Hn described above is separated (grouped) into a plurality of nozzle groups (two nozzle groups Hna, Hnb in this example). Similarly, the plurality of channels C described above is separated into a plurality of channel groups (two channel groups Ca, Cb in this example). Further, in the example in FIG. 2, a nozzle group Ga and the channel group Ca belong a group Ga, and a nozzle group Gb and the channel group Cb belong a group Gb. It is arranged that the drive signals Sda (the drive voltages Vda) described above are supplied to the group Ga, and the drive signals Sdb (the drive voltages Vdb) described above are supplied to the group Gb. As an example of such nozzle groups Hna, Hnb, nozzle arrays extending along a predetermined direction in the nozzle plate 112 can be cited, and as an example of the channel groups Ca, Cb, channel arrays arranged so as to correspond respectively to the nozzle arrays in the actuator plate 111 can be cited. It should be noted that this example is not a limitation, and it is possible to arrange that the nozzle groups and the channel groups are set using other grouping methods.

### Detailed Configuration of Drive Circuits 41

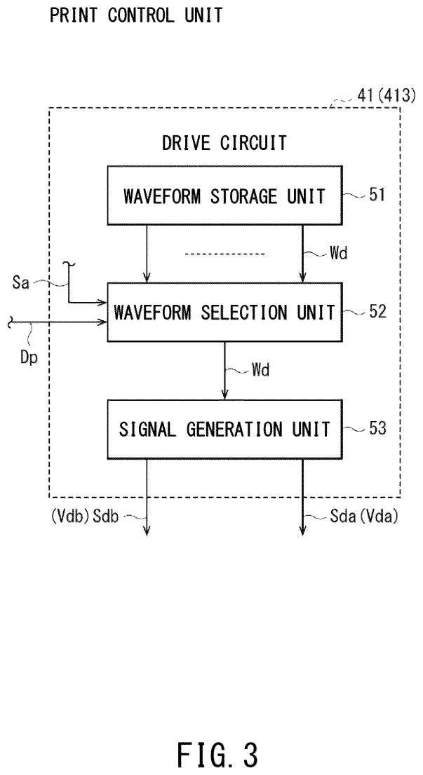

Then, a detailed configuration example of the drive circuits 41 in the inkjet head 1 will be described with reference to FIG. 3 to FIGS. 5A, 5B in addition to FIG. 1 and FIG. 2.

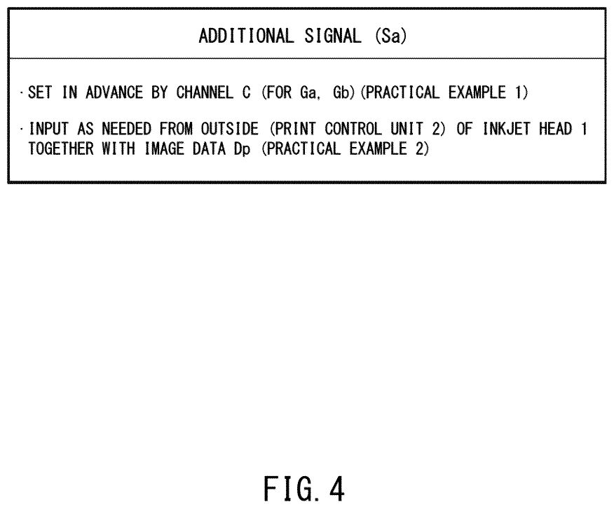

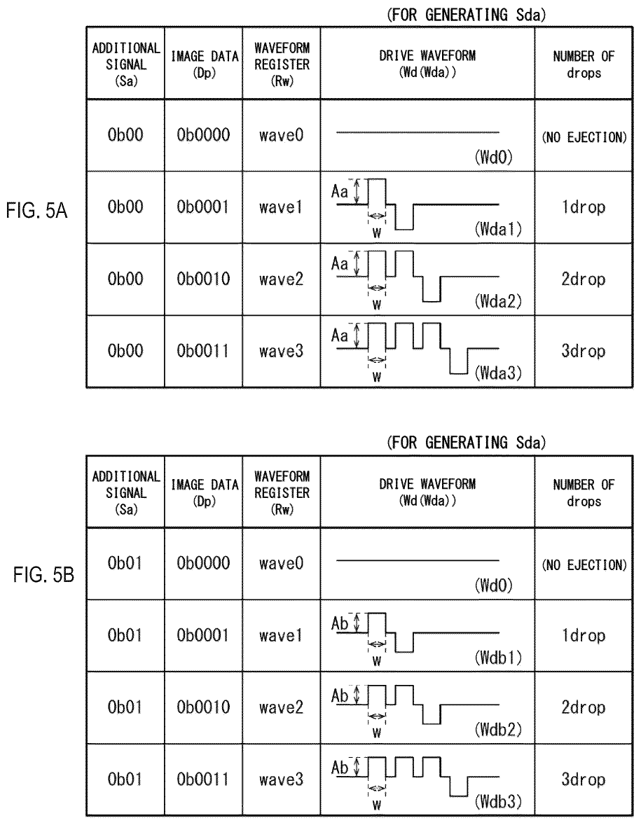

FIG. 3 is a block diagram showing the detailed configuration example of the drive circuits 41 (in particular the drive circuit 413 described above) shown in FIG. 2. FIG. 4 is a diagram showing a detailed configuration example of an additional signal Sa which is described later and is shown in FIG. 3. Further, FIGS. 5A and 5B are each a diagram schematically showing a configuration example of drive waveforms Wd stored in the waveform storage unit 51 shown in FIG. 1 to FIG. 3, and so on. Specifically, in FIGS. 5A and 5B described above, there is shown an example of a correspondence relationship among the drive waveforms Wd stored in the waveform storage unit 51, the additional signal Sa described later, the image data Dp, a waveform register Rw, and the number of drops. Further, in FIG. 5A, an example of the correspondence relationship among drive waveforms Wda as the drive waveforms Wd to be used when generating the drive signals Sda described above, and so on, and in FIG. 5B, an example of the correspondence relationship among drive waveforms Wdb as the drive waveforms Wd to be used when generating the drive signals Sdb described above, and so on.

As shown in FIG. 3, the drive circuit 413 is arranged to generate the drive signals Sda, Sdb (the drive voltages Vda, Vdb) described above based on the image data Dp which defines the drive waveforms Wd and the additional signal Sa described later. This drive circuit 413 includes the waveform storage unit 51 which stores a plurality of types of drive waveforms Wd described later, a waveform selection unit 52, and a signal generation unit 53.

### Waveform Storage Unit 51

In the waveform storage unit 51, as shown in, for example, FIG. 5A and FIG. 5B, the plurality of types of drive waveforms Wd (Wda, Wdb) associated with the image data Dp is stored in predetermined regions in the waveform register Rw.

Specifically, the drive waveforms Wda to be used when generating the drive signals Sda shown in FIG. 5A are arranged as follows. That is, the drive waveform Wda=Wd0 in the case of “NO EJECTION” which corresponds to the image data Dp with a pixel value of “0b0000” is stored in a region of the waveform register Rw=“wave0.” Similarly, the drive waveform Wda=Wda1 in the case of “1 drop” which corresponds to the image data Dp with a pixel value of “0b0001” is stored in a region of the waveform register Rw=“wave1.” The drive waveform Wda=Wda2 in the case of “2 drop” which corresponds to the image data Dp with a pixel value of “0b0010” is stored in a region of the waveform register Rw=“wave2.” The drive waveform Wda=Wda3 in the case of “3 drop” which corresponds to the image data Dp with a pixel value of “0b0011” is stored in a region of the waveform register Rw=“wave3.”

Meanwhile, the drive waveforms Wdb to be used when generating the drive signals Sdb shown in FIG. 5B are arranged as follows. That is, the drive waveform Wdb=Wd0 in the case of “NO EJECTION” which corresponds to the image data Dp with a pixel value of “0b0000” is stored in a region of the waveform register Rw=“wave0.” Similarly, the drive waveform Wdb=Wdb1 in the case of “1 drop” which corresponds to the image data Dp with a pixel value of “0b0001” is stored in a region of the waveform register Rw=“wave1.” The drive waveform Wdb=Wdb2 in the case of “2 drop” which corresponds to the image data Dp with a pixel value of “0b0010” is stored in a region of the waveform register Rw=“wave2.” The drive waveform Wdb=Wdb3 in the case of “3 drop” which corresponds to the image data Dp with a pixel value of “0b0011” is stored in a region of the waveform register Rw=“wave3.”

Here, when the additional signal Sa is set as Sa=“0b00,” the drive waveforms Wda=Wd0, Wda1, Wda2, Wda3 used for generating the drive signals Sda are defined by the image data Dp=“0b0000,” “0b0001,” “0b0010,” “0b0011,” respectively (see FIG. 5A). Meanwhile, when the additional signal Sa is set as Sa=“0b01,” the drive waveforms Wdb=Wd0, Wdb1, Wdb2, Wdb3 used for generating the drive signals Sdb are defined by the image data Dp=“0b0000,” “0b0001,” “0b0010,” “0b0011,” respectively (see FIG. 5B).

Further, in the plurality of types of drive waveforms Wda, Wdb defined by the additional signal Sa in this way, amplitude values are different from each other in the examples in FIG. 5A and FIG. 5B. Specifically, an amplitude value Aa in the drive waveforms Wda=Wda1, Wda2, Wda3 defined by the additional signals Sa=“0b00” and an amplitude value Ab in the drive waveforms Wdb=Wdb1, Wdb2, Wdb3 defined by the additional signals Sa=“0b01” are different from each other ((amplitude value Aa)>(amplitude value Ab)). It should be noted that it is also possible to arrange that waveform widths W in the plurality of types of drive waveforms Wda, Wdb defined by the additional signal Sa are different from each other.

### Waveform Selection Unit 52

As shown in FIG. 3, the waveform selection unit 52 is for selecting the drive waveform Wd from the plurality of types of drive waveforms Wd stored in the waveform storage unit 51 based on the image data Dp and the additional signal Sa described above. Specifically, the waveform selection unit 52 is arranged to be capable of selecting the drive waveforms Wd different in type from each other based on the same image data Dp by using the additional signal Sa as, for example, FIG. 5A and FIG. 5B described above.

That is, based on the same image data Dp=“0b0001,” the drive waveform Wda1 described above is selected in the case of the additional signal Sa=“0b00,” and the drive waveform Wdb1 described above is selected in the case of the additional signal Sa=“0b01.” Similarly, based on the same image data Dp=“0b0010,” the drive waveform Wda2 described above is selected in the case of the additional signal Sa=“0b00,” and the drive waveform Wdb2 described above is selected in the case of the additional signal Sa=“0b01.” Further, based on the same image data Dp=“0b0011,” the drive waveform Wda3 described above is selected in the case of the additional signal Sa=“0b00,” and the drive waveform Wdb3 described above is selected in the case of the additional signal Sa=“0b01.”

### Signal Generation Unit 53

As shown in FIG. 3, the signal generation unit 53 is for generating the drive signal Sd based on the drive waveform Wd selected by the waveform selection unit 52. Specifically, when the drive waveform Wda (=(either one of Wd0, Wda1, Wda2, and Wda3)) is selected by the waveform selection unit 52, the signal generation unit 53 generates the drive signal Sda (the drive voltage Vda) based on that drive waveform Wda. Further, when the drive waveform Wdb (=(either one of Wd0, Wdb1, Wdb2, and Wdb3)) is selected by the waveform selection unit 52, the signal generation unit 53 generates the drive signal Sdb (the drive voltage Vdb) based on that drive waveform Wdb. It should be noted that the drive signals Sda, Sdb which have the plurality of types of drive waveforms Wd and are generated in this way are arranged to be output to the respective groups Ga, Gb (the respective channel groups Ca, Cb, the respective nozzle groups Hna, Hnb) described above (See FIG. 2).

In this way, in the present embodiment, the following configuration is adopted in at least one drive circuit 41 (the drive circuit 413 in the example in FIG. 2 and FIG. 3) out of the drive circuits 41 (411 to 415). That is, in the drive circuit 413, it is arranged that the drive signals Sda, Sdb which have the plurality of types of drive waveforms Wda, Wdb defined by the additional signal Sa are generated based on the same image data Dp, and are output to the jet section 11.

Further, it is arranged that this additional signal Sa is set in such a manner as shown in Practical Example 1 or Practical Example 2 shown in FIG. 4. That is, in Practical Example 1, it is arranged that the additional signal Sa is set in advance by the channel C (e.g., for each of the groups Ga, Gb described above). In contrast, in Practical Example 2, it is arranged that the additional signal Sa is input on an as needed basis together with the image data Dp at the time of data transfer from the outside (the print control unit 2) of the inkjet head 1.

### Operations, and Functions and Advantages

### A. Basic Operation of Printer 5

In this printer 5, a recording operation (a printing operation) of images, characters, and so on to the recording target medium (the recording paper P and so on) is performed using such a jet operation of the ink 9 by the inkjet head 1 as described below. Specifically, in this inkjet head 1, the jet operation of the ink 9 using a shear mode is performed in the following manner.

First, the drive circuits 41 (411 to 415) on the drive board 13 apply the drive voltages Vd (the drive signals Sd) to the drive electrodes (the common electrodes and the active electrodes) described above in the actuator plate 111 in the jet section 11. Specifically, the drive circuit 41 applies the drive voltage Vd to the drive electrodes disposed on the pair of drive walls partitioning the ejection channel described above. Thus, the pair of drive walls each deform so as to protrude toward the dummy channel adjacent to the ejection channel.

On this occasion, it results in that the drive wall makes a flexion deformation to have a V shape centering on an intermediate position in the depth direction in the drive wall. Further, due to such a flexion deformation of the drive wall, the ejection channel deforms as if the ejection channel bulges. As described above, due to the flexion deformation caused by a piezoelectric thickness-shear effect in the pair of drive walls, the volume of the ejection channel increases. Further, by the volume of the ejection channel increasing, the ink 9 is induced into the ejection channel as a result.

Subsequently, the ink 9 induced into the ejection channel in such a manner turns to a pressure wave to propagate to the inside of the ejection channel. Then, the drive voltage Vd to be applied to the drive electrodes becomes 0 (zero) V at a timing at which the pressure wave has reached the nozzle hole Hn of the nozzle plate 112 (or a timing around that timing). Thus, the drive walls are restored from the state of the flexion deformation described above, and as a result, the volume of the ejection channel having once increased is restored again.

In such a manner, the pressure inside the ejection channel increases in the process that the volume of the ejection channel is restored, and thus, the ink 9 in the ejection channel is pressurized. As a result, the ink 9 shaped like a droplet is ejected toward the outside (toward the recording paper P) through the nozzle hole Hn (see FIG. 1). The jet operation (the ejection operation) of the ink 9 in the inkjet head 1 is performed in such a manner, and as a result, the recording operation of images, characters, and so on to the recording paper P is performed.

### B. Operation of Generating Drive Signals Sd

Then, a signal generation operation (an operation of generating the drive signals Sd) in the drive circuit 41 in the present embodiment will be described in detail in comparison with a comparative example.

First, in the related-art inkjet head, in general, when applying a drive waveform to an actuator, a current flows when performing charge and discharge in the actuator, and most of the current flow causes a heat loss. Therefore, when performing, for example, high-speed printing, it is desirable to reduce the power consumption so as to reduce the heat generation. As one of the methods of reducing the power consumption, a method of decreasing the drive voltage can be cited. Since the power consumption of a capacitive load is obtained as (C×V²) using a capacitance (C) and the drive voltage (V), by decreasing the drive voltage, the power consumption is decreased, and the heat generation can be suppressed.

However, when simply decreasing the drive voltage, the drive force of the actuator is decreased, and therefore, there is a method of increasing the drive voltage in a stepwise manner using a plurality of types of power supplies. For example, considering when setting an intermediate potential (e.g., 5 V when an upper limit is 10 V) to positive and negative drive power sources, the power consumption is reduced by half (½) when raising the voltage in a stepwise manner of (0 V→5 V→10 V) compared to when raising the voltage by 10 V at a time. Further, by making a transition of the drive waveform in a stepwise manner, an improvement of the printing quality is achieved. In this way, when the number of positive and negative drive power sources is no larger than one, the drive waveform is determined by defining only the waveform width as the information of the drive waveform. However, when the number of positive and negative drive power sources is no smaller than two as described above, it is necessary to define an amplitude value (potential) in addition to the waveform width as the information of the drive waveform, and therefore, the drive waveform data becomes complicated as a result.

Incidentally, in the actuator, it is necessary to change the drive voltage due to a variation in a piezoelectric element material or a variation in manufacturing processing. For example, when actuator arrays different from each other are stacked on one another and used, it is necessary to set the drive voltage for each of the arrays since the drive voltages are different from each other, and therefore, it is necessary to set drive waveform data different from each other to the respective arrays. Further, when driving, for example, a long actuator, a plurality of drive circuits (driver ICs) is implemented to drive the actuator. Therefore, the number of piezoelectric elements (the number of nozzles) which can be driven by the drive circuits is determined by the number of drive circuits.

Further, there are a variety of methods of actuators, and in the actuator using, for example, PZT (lead zirconate titanate), a bulk wafer to be actuators are carved out to be used in some cases. In this case, a size in a nozzle array direction of the actuator is determined by a size of the original bulk. It is possible to change the bulk size product by product, but the number of pieces obtained from each size decreases to increase the cost, and therefore, it is desirable to use the same bulk in a plurality of products. Therefore, the maximum number of nozzles which can be formed in one array is determined by the wafer size of the actuator and the resolution, and when the maximum number is not an integer multiple of the number of channels in the drive circuit, a remainder occurs in the number of channels of the drive circuit or the number of nozzles as a result. Since the price of the inkjet head is compared using a unit price per nozzle as a guide in some cases, when the remainder occurs in the number of channels of the drive circuit or the number of nozzles, the price rises, which is disadvantageous to the comparison result.

Therefore, as a method of solving such a problem, there is a method of sharing the output of the drive circuit with a plurality of nozzle groups (nozzle arrays or the like) as in, for example, the present embodiment. Specifically, when the number of piezoelectric elements which can be formed in one array of actuators corresponds to 2.5 drive circuits, 5 drive circuits are arranged on one board, and one of the 5 drive circuits is shared half-and-half with two arrays. In this way, since the actuators can be used without waste together with the drive circuits, it becomes possible to decrease the unit price of the nozzle.

However, in order to ensure the printing quality in the case described above, it is necessary to adjust, for example, the drive voltage for each actuator array due to production tolerance as described above. Assuming two actuator arrays as an array A and an array B, when information of an amplitude value (potential) is included in the drive waveform data, it is necessary to set drive waveform data the same in waveform width and different in amplitude value respectively to the two actuator arrays.

Therefore, as in, for example, the comparative example described below, it is necessary to set image data different between the array A and the array B although the number of drops is the same at the printer side. Therefore, although it is sufficient to process the print image into the respective number of drops in normal conditions, when the drive waveform data is different between the array A and the array B as described above, a necessity of performing image processing arises, and the processing becomes complicated.

### B-1. Comparative Example

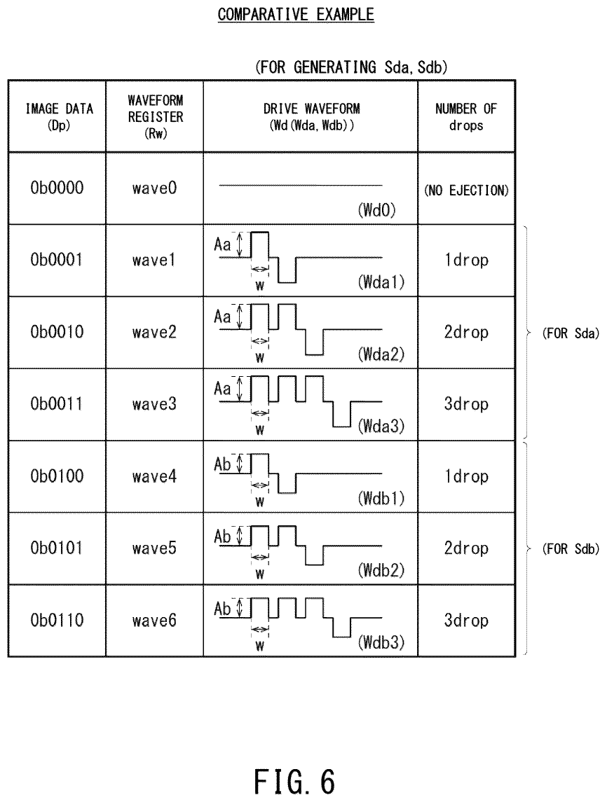

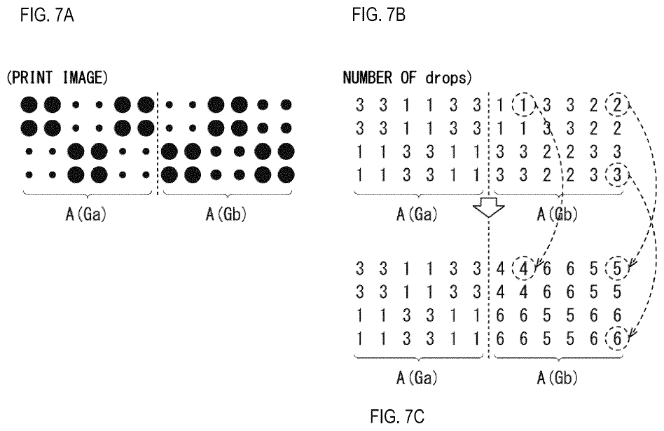

Here, FIG. 6 a diagram schematically showing a configuration example of drive waveforms Wd stored in the waveform storage unit related to the comparative example and so on. Specifically, in FIG. 6 described above, there is shown an example of a correspondence relationship among the drive waveforms Wd (Wda, Wdb) stored in the waveform storage unit related to the comparative example, the image data Dp, the waveform register Rw, and the number of drops. Further, FIGS. 7A to 7C are diagrams schematically showing an example of a correspondence relationship among the print image (FIG. 7A), the number of drops (FIG. 7B), and the image data Dp (FIG. 7C) related to this comparative example.

In the comparative example shown in FIG. 6, unlike the case (see FIGS. 5A and 5B) of the present embodiment described above, it is arranged that the drive waveform Wd is selected from the plurality of types of drive waveforms Wd (Wda, Wdb) based only on the image data Dp, and both the drive signals Sda, Sdb described above are generated.

Specifically, in the comparative example shown in FIG. 6, regarding the drive waveforms Wda to be used when generating the drive signals Sda, the following relationship is provided similarly to the case of the present embodiment shown in FIG. 5A. That is, the drive waveform Wda=Wd0 in the case of “NO EJECTION” which corresponds to the image data Dp with a pixel value of “0b0000” is stored in a region of the waveform register Rw=“wave0.” Similarly, the drive waveform Wda=Wda1 in the case of “1 drop” which corresponds to the image data Dp with a pixel value of “0b0001” is stored in a region of the waveform register Rw=“wave1.” The drive waveform Wda=Wda2 in the case of “2 drop” which corresponds to the image data Dp with a pixel value of “0b0010” is stored in a region of the waveform register Rw=“wave2.” The drive waveform Wda=Wda3 in the case of “3 drop” which corresponds to the image data Dp with a pixel value of “0b0011” is stored in a region of the waveform register Rw=“wave3.”

On the other hand, in the comparative example shown in FIG. 6, regarding the drive waveforms Wdb to be used when generating the drive signals Sdb, the following relationship is provided unlike the case of the present embodiment shown in FIG. 5B. That is, the drive waveform Wdb=Wdb1 in the case of “1 drop” which corresponds to the image data Dp with a pixel value of “0b0100” is stored in a region of the waveform register Rw=“wave4.” The drive waveform Wdb=Wdb2 in the case of “2 drop” which corresponds to the image data Dp with a pixel value of “0b0101” is stored in a region of the waveform register Rw=“wave5.” The drive waveform Wdb=Wdb3 in the case of “3 drop” which corresponds to the image data Dp with a pixel value of “0b0110” is stored in a region of the waveform register Rw=“wave6.”

Further, similarly to the present embodiment, in this comparative example, when the drive waveform Wda is selected, the drive signal Sda (the drive voltage Vda) is generated based on that drive waveform Wda. Meanwhile, when the drive waveform Wdb is selected, the drive signal Sdb (the drive voltage Vdb) is generated based on that drive waveform Wdb.

Due to such a configuration, in the inkjet head in the comparative example, for example, when printing the print image in two regions A(Ga), A(Gb) corresponding to the groups Ga, Gb described above as shown in, for example, FIG. 7A, the following is achieved. That is, as indicated by, for example, dotted arrows in FIG. 7B, regarding the pixels in the region A(Gb), there arises a necessity of making the value (the pixel value) of the image data Dp different even when the number of drops is the same as that of the pixel in the region A(Ga).

In this way, in the comparative example, since it is necessary to define the different image data Dp respectively for the plurality of types of drive waveforms Wd (Wda, Wdb), the drive circuit which outputs each of the drive signals Sd (Sda, Sdb) having the plurality of types of drive waveforms Wd becomes complicated in configuration. As a result, it can be said that it is difficult in this comparative example to improve the convenience while achieving the reduction in cost.

### B-2. Present Embodiment

In contrast, in the inkjet head 1 according to the present embodiment, unlike the case of the comparative example, it is arranged that the drive signals Sda, Sdb in terms of the groups Ga, Gb (the channel groups Ca, Cb, the nozzle groups Hna, Hnb) are respectively generated in the following manner (see FIG. 3 to FIGS. 5A and 5B). That is, in the present embodiment, as described above, the drive signals Sda, Sdb which have the plurality of types of drive waveforms Wda, Wdb defined by the additional signal Sa are generated based on the same image data Dp in at least one drive circuit 41 (the drive circuit 413).

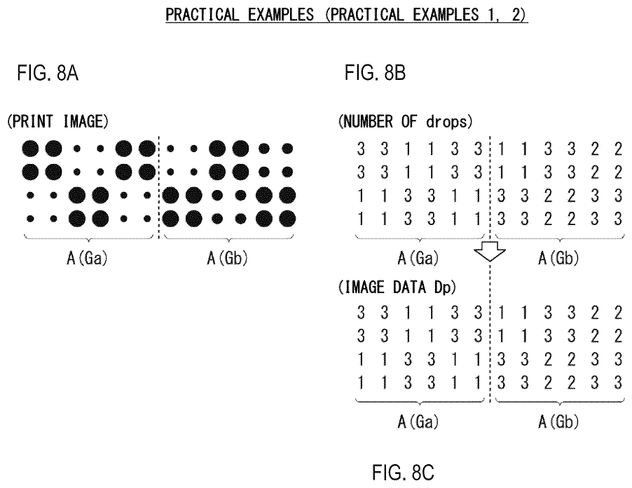

FIGS. 8A to 8C are diagrams schematically showing an example of a correspondence relationship among the print image (FIG. 8A), the number of drops (FIG. 8B), and the image data Dp (FIG. 8C) related to practical examples (Practical Examples 1, 2) of the present embodiment.

In the practical examples shown in FIGS. 8A to 8C, unlike the case of the comparative example shown in FIGS. 7A to 7C, when printing the print image in the two regions A(Ga), A(Gb) corresponding to the groups Ga, Gb as shown in, for example, FIG. 8A, the following is achieved. That is, by using the additional signal Sa described above, it becomes possible to apply the same value (the pixel value) of the image data Dp when the number of drops is the same in the two regions A(Ga), A(Gb) different from each other as shown in, for example, FIG. 8B and FIG. 8C.

### B-3. Functions/Advantages

In this way, in the present embodiment, there is adopted the configuration in which in at least one drive circuit 41, the drive signals Sd having a plurality of types of drive waveforms Wd defined by the additional signal Sa are respectively formed based on the same image data Dp, and are then output to the jet section 11. Accordingly, unlike the comparative example described above, for example, since there is no need to define different image data Dp respectively for the plurality of types of drive waveforms Wd, it becomes possible to respectively output the drive signals Sd having the plurality of types of drive waveforms Wd from at least one drive circuit 41 described above with a simple configuration. Further, since it becomes easy to appropriately set the relationship between the number of drive circuits 41 and the number of nozzle holes Hn, in the present embodiment, it becomes possible to improve the convenience while achieving the reduction in cost compared to the case of the comparative example described above.

Further, in the present embodiment, when it is arranged that the additional signal Sa is set in advance for each channel C (Practical Example 1), it becomes possible to respectively output the drive signals Sd having the plurality of types of drive waveforms Wd with a simpler configuration. As a result, it becomes possible to achieve a further reduction in cost.

Further, in the present embodiment, when it is arranged that the additional signal Sa is input on an as needed basis together with the image data Dp from the outside of the inkjet head 1 (Practical Example 2), an output setting of the drive signals Sd having the plurality of types of drive waveforms Wd can be changed on an as needed basis (on a timely basis). As a result, it becomes possible to further enhance the convenience.

### 2. Modified Example

The present disclosure is described hereinabove citing the embodiment and some practical examples, but the present disclosure is not limited to the embodiment and so on, and a variety of modifications can be adopted.

For example, in the embodiment and so on described above, the description is presented specifically citing the configuration examples (the shape, the arrangement, the coupling configuration, the type, the number, and so on) of the members (the drive circuits and the groups, the channel groups, the nozzle groups, the variety of types of signal lines, and so on) in the printer and the inkjet head. It should be noted that these configuration examples are not limited to the configuration examples described in the embodiments and so on described above, and it is possible to adopt other shapes, arrangement, coupling configurations, types, numbers, and so on.

Specifically, for example, the configuration of the I/F board and the drive board is not limited to what is explained in the embodiments and so on described above, and it is possible to adopt other configurations. Further, in the embodiment and so on described above, the description is presented citing when the single drive board is disposed alone as an example, but two or more drive boards, for example, can be disposed. Further, in the embodiment and so on described above, there is described when the I/F board as a relay board is disposed inside the inkjet head, but this is not a limitation, and it is possible to eliminate such a relay board (the I/F board) from, for example, the inkjet head. In addition, in the embodiment and so on described above, the description is presented specifically citing the example of the correspondence relationship among a variety of drive waveforms and image data, the waveform register, the number of drops, and the additional signal, but the correspondence relationship among these is not limited to the example cited in the embodiment and so on described above. In addition, in the embodiment and so on described above, the description is presented citing the example when the plurality of drive circuits is cascaded each other via the common signal line group as an example, but this example is not a limitation.

Further, a variety of types of structures can be adopted as the structure of the inkjet head. Specifically, for example, it is possible to adopt a so-called side-shoot type inkjet head which emits the ink 9 from a central portion in the extending direction of each of the ejection channels in the actuator plate 111. Alternatively, it is possible to adopt, for example, a so-called edge-shoot type inkjet head for ejecting the ink 9 along the extending direction of each of the ejection channels. Further, the type of the printer is not limited to the type described in the above embodiment and so on, and it is possible to apply a variety of types such as an MEMS (Micro Electro-Mechanical Systems) type.

Further, for example, it is possible to apply the present disclosure to either of an inkjet head of a circulation type which uses the ink 9 while circulating the ink 9 between the ink tank and the inkjet head, and an inkjet head of a non-circulation type which uses the ink 9 without circulating the ink 9.

Further, the series of processing described in the above embodiments and so on can be arranged to be performed by hardware (a circuit), or can also be arranged to be performed by software (a program). When it is arranged that the series of processing is performed by the software, the software is constituted by a program group for making the computer perform the functions. The programs can be incorporated in advance in the computer described above to be used by the computer, for example, or can also be installed in the computer described above from a network or a recording medium to be used by the computer.

Further, in the above embodiments and so on, the description is presented citing the printer (the inkjet printer) as a specific example of the “liquid jet recording apparatus” in the present disclosure, but this example is not a limitation, and it is also possible to apply the present disclosure to other apparatuses than the inkjet printer. In other words, it is also possible to arrange that the “liquid jet head” (the inkjet head) of the present disclosure is applied to other apparatuses than the inkjet printer. Specifically, it is also possible to arrange that the “liquid jet head” of the present disclosure is applied to an apparatus such as a facsimile or an on-demand printer.

In addition, it is also possible to apply the variety of examples described hereinabove in arbitrary combination.

It should be noted that the advantages described in the present specification are illustrative only, but are not a limitation, and other advantages can also be provided.

Further, the present disclosure can also take the following configurations.
(1)

A Liquid Jet Head Including
a jet section including a plurality of nozzles and a plurality of pressure chambers individually communicated with the plurality of nozzles, and
a single drive circuit or a plurality of drive circuits configured to generate a drive signal for jetting a liquid from the nozzle based on image data defining a drive waveform and an additional signal, wherein
in at least one drive circuit out of the single drive circuit or the plurality of drive circuits,
the drive signals having the drive waveforms of a plurality of types defined by the additional signal are configured to be respectively generated based on the same image data and to be output to the jet section.
(2)

The liquid jet head according to (1) described above, wherein
the drive circuit includes
a waveform storage unit configured to store the drive waveforms of the plurality of types,
a waveform selection unit configured to select the drive waveform based on the image data and the additional signal, and
a signal generation unit configured to generate the drive signal based on the drive waveform selected by the waveform selection unit, and
the waveform selection unit is configured to select the drive waveforms different in type based on the same image data by using the additional signal.
(3)

The liquid jet head according to (1) or (2) described above, wherein
the additional signal is set in advance by the pressure chamber.
(4)

The liquid jet head according to (1) or (2) described above, wherein
the additional signal is configured to be input on an as needed basis from an outside of the liquid jet head together with the image data.
(5)

The liquid jet head according to any one of (1) to (4) described above, wherein
an amplitude value or a waveform width is different between the drive waveforms of the plurality of types defined by the additional signal.
(6)

The liquid jet head according to any one of (1) to (5) described above, wherein
the plurality of nozzles is separated into a plurality of nozzle groups, and
the drive signals having the drive waveforms of the plurality of types are configured to be output for the respective nozzle groups.
(7)

The liquid jet head according to any one of (1) to (6) described above, wherein
a plurality of drive circuits each identical to the drive circuit is provided, and
the plurality of drive circuits is cascaded to each other via a common signal line group.
(8)

A liquid jet recording apparatus including
the liquid jet head according to any one of (1) to (7) described above.

What is claimed is:

1. A liquid jet head comprising:
a jet section including a plurality of nozzles and a plurality of pressure chambers individually communicated with the plurality of nozzles; and
a single drive circuit or a plurality of drive circuits configured to generate a drive signal for jetting a liquid from the nozzle based on image data defining a drive waveform and an additional signal, wherein
in at least one drive circuit out of the single drive circuit or the plurality of drive circuits,
the drive signals having the drive waveforms of a plurality of types defined by the additional signal are configured to be respectively generated based on the same image data and to be output to the jet section.

2. The liquid jet head according to claim 1, wherein
the drive circuit includes
a waveform storage unit configured to store the drive waveforms of the plurality of types,
a waveform selection unit configured to select the drive waveform based on the image data and the additional signal, and
a signal generation unit configured to generate the drive signal based on the drive waveform selected by the waveform selection unit, and
the waveform selection unit is configured to select the drive waveforms different in type based on the same image data by using the additional signal.

3. The liquid jet head according to claim 1, wherein
the additional signal is set in advance by the pressure chamber.

4. The liquid jet head according to claim 1, wherein
the additional signal is configured to be input on an as needed basis from an outside of the liquid jet head together with the image data.

5. The liquid jet head according to claim 1, wherein
an amplitude value or a waveform width is different between the drive waveforms of the plurality of types defined by the additional signal.

6. The liquid jet head according to claim 1, wherein
the plurality of nozzles is separated into a plurality of nozzle groups, and
the drive signals having the drive waveforms of the plurality of types are configured to be output for the respective nozzle groups.

7. The liquid jet head according to claim 1, wherein
a plurality of drive circuits each identical to the drive circuit is provided, and
the plurality of drive circuits is cascaded to each other via a common signal line group.

8. A liquid jet recording apparatus comprising:
the liquid jet head according to claim 1.
